(19) United States
(12) Patent Application Publication
(10) Pub. No.: US 2011/0210860 A1
(43) Pub. Date: Sep. 1, 2011

(54) USB Port Connectible Device Locater

(76) Inventor: Chih-Cheng Kuo, Spring, TX (US)

(21) Appl. No.: 12/713,194

(22) Filed: Feb. 26, 2010

(51) Int. Cl. G08B 21/00

(52) U.S. Cl. 340/663

(57) ABSTRACT

Alarm control circuitry is provided for a Universal Serial Bus (USB) port connectible device including an alarm generator emitting an audible alarm when powered by internal voltage from a capacitor charged by external voltage from a computer during connection of the device to a computer and actuated with a power off detection circuit in the condition that termination of power from the computer to the device is detected. Provision for an optional base unit with passive RFID in the alarm control circuitry includes an RF transceiver, ID reader, timer and counter causing alarm activation if a ‘reflected’ RF signal is not received in a certain amount of time. An exemplary power off detection circuit outputs an alarm control signal digital logic ‘1’ in alarm generator actuation using an AND gate fed by internal voltage and external voltage reverse logic.

### BACKGROUND OF THE INVENTION

1. Field of the Invention

The present invention relates: generally to electrical communications (US Class 340) with condition responsive indicating systems (340/500) that have a particular coupling link (340/531); more specifically to electrical communications with condition responsive indicating systems that have a particular coupling link utilized upon Universal Serial Bus (USB) port connectible devices; and most particularly to electrical communications with condition responsive indicating systems wherein the particular coupling link is article placement or removal (340/568.1) wherein the article is a USB port connectible device connected to the USB port of a computer.

2. General Background

USB port connectible devices are almost universally known. The success enjoyed by these devices is considered to be owed, apart from the superior Input/Output technology enabling faster communication with the host system, to the mechanical construction of USB ports and the congruent connector portion of a USB port connectible device inserted therein. While the port is superficially female and the mating portion superficially male the electrical conductors are apposed blades biased against each other and interior to cavities and hence not subject to damage and do not rely on pin configuration for sense alignment but upon the alternately opposed cavities within a universal and compact connector block that is easily and safely inserted into a USB port practically ad infinitum. This mechanical configuration is, in brief, considered important to the rapid ascent of USB port connectible devices in use.

Prior to USB connectors multi-pin serial and parallel connectors typically had two threaded or wire cage ‘snap’ fasteners. These multi-pin connectors were much larger than the USB configuration, were comparatively difficult and tedious to connect securely, and while still in use for connections not expected to be repeated frequently are considered obsolete for port connectible device connections made repeatedly. Serial connectors replaced parallel connectors as the system of choice for connector buses in computers because serial bus communication is much faster than parallel. A bus is a multiple electrical connection platform eminently suited to digital technology.

Aside from purely technical aspects the point to be taken here is that, in addition to the modest ‘footprint’ or area required for a multi-conductor serial bus connection, the mechanical superiority of the USB connection enabling easily repeated connection and disconnection is considered at least partly responsible for the relatively explosive ascent in the popularity of USB port connectible devices and is also considered to present, ironically, a problem because as a USB port connectible device is so easily connected and disconnected to a computer or other digital electronic device, it is also very easily forgotten as to which computer it was connected especially in an environment with a plurality of computers each operable from a single ‘workstation’.

Many computer environments have a plurality of computers that are also often ‘networked’: id est linked together; either to a plurality of computer workstations or perhaps a single workstation typically having, in addition to a monitor, a keyboard and a ‘mouse’ or other cursor control and input ‘peripherals’. Regardless of the number of workstations having a plurality of computers networked and hence usable from any particular workstation enables one to connect a USB port connectible device to any one of the plurality of these computers networked together for use at a single workstation.

3. Discussion of the Prior Art

The most pertinent know prior art reference is U.S. Pat. No. 6,459,374 for an ‘Anti-Theft Computer Security System’ which discloses “a USB connector” with a cable extending “through the housing section” “connected to a central alarm monitoring unit” and intended to protect a computer from theft as an “alarm sounds” if “the USB connector is disconnected from the computer . . . or if the cable is cut” (Abstract).

U.S. Pat. No. 6,462,661 titled ‘RF ID tag attachment to a disc drive’ issued to Pfeiffer et allis and assigned to Seagate Technology discloses attachment of a RFID tag to a disc drive spacing the tag from the disc port connectible device housing with a post held in a hole in the housing by some resilient material that was considered: “Useful for recording completion of production processes in a clean room environment”. (Abstract)

U.S. Pat. No. 6,919,805 for a ‘Wallet with Alarm Device Installed Therein’ discloses use of an oscillation plate “installed between the outer cover and the inner layer of the wallet, and a photo sensor” responsive to visible light causing “a melody (to be) generated so that the owner can recognize the departure”. (Abstract)

The most pertinent art known addressing the problem of inadvertently leaving a USB port connectible device behind is that of the present inventor in the form of U.S. application Ser. No. 12/647,563 for a ‘USB Port Connectible Device Reminder’ which uses radio frequency (RF) transmission, from a device powered by a computer through a USB port, to an associated portable base carried by the owner with a RF receiver and battery powered alarm triggered by exceeding a limited range of the RF transmission.

This application, being in the name of the present inventor, is not prior art and requires, moreover, a remote base unit associated with the USB port connectible device with RF receiver, alarm, and a battery to power that alarm.

4. Statement of Need

While a number of specific articles, each particularly addressed in a US Patent, are known to have been protected with use of remote: wireless; communication activated in response to a sensed or detected condition: particularly relating to location, placement or removal of the protected article with said communication being received by another specific remote device; the only known use of a USB port connectible device in the pertinent prior art utilizes wired remote communication to a central alarm for the purpose of protecting a computer from theft. No prior art is known that is concerned with the problem of forgetting to which computer a USB port connectible device was connected.

The ‘USB Port Connectible Device Reminder’ will result in the alarm being triggered if the USB port connectible device is removed from a computer while connected thereto as loss of RF reception by the associated portable base triggers the remote base alarm, but if it is forgotten to which particular computer from a plurality of computers networked together the USB port connectible device was connected, an alarm on a base carried by the owner is useless in locating the USB port connectible device. To which computer, particularly if all appear identical, was the USB port connectible device left connected?

This may seem a trivial problem but the ramifications of becoming flustered, especially during a business meeting or sales demonstration, et cetera are difficult to underestimate. An important deal, job, sale, et cetera may be readily lost by the appearance of being absent minded or in less than perfect control everything done. Simple ‘body language’ often becomes a criteria for judging other people in such situations and complete presence of mind often essential for success as others in a group may have their own reasons to find some fault, however small, for criticism.

Other drawbacks to the ‘USB Port Connectible Device Reminder’ or discerned regardless of the social situation in which a USB port connectible device is connected to a computer or whether the computer environment has a plurality of computers. A portable base, associated with the USB device, possessing an alarm, a battery to power the alarm, and RF reception circuitry, is required of the ‘USB Port Connectible Device Reminder’. In brief the necessity of a unit separate from the USB port connectible device is a drawback by definition as comprising an additional device but the main point is that it is a ‘Reminder’: it reminds one that the USB port connectible device has been left behind; but it does nothing to help locate that USB port connectible device. If the computer to which a USB port connectible device is connected is ‘turned off’, or the USB port connectible device is ‘shut down’ by workstation input, the ‘Reminder’ will notify the possessor of the portable base unit with activation of the alarm but will do nothing to facilitate location of that USB port connectible device.

Lastly, if the USB port connectible device is removed from a computer to which it has been connected, by the owner of the device or by another person, an alarm will be actuated in both the ‘Reminder’ and the only known pertinent prior art: U.S. Pat. No. 6,459,374 for an ‘Anti-Theft Computer Security System’. If the owner removes the USB port connectible device it is assumed there is no problem unless other very similar if not identical devices in physical appearance happen to be connected to the same computer or to another computer nearby in which case how is the owner sure that they have positively located the USB port connectible device that is theirs?

A need is hence recognized for a means of facilitating location of and positively locating a USB port connectible device after connection to a computer through a USB port.

### SUMMARY OF THE INVENTION

Objects of the Invention

The principal object of the present invention is facilitating location of a USB port connectible device after connection of the device, through a USB port, to one of a plurality of computers networked together and all usable from a single workstation.

A first auxiliary object of the present invention is facilitating location of a USB port connectible device after connection to a computer through a USB port when power to the USB port connectible device is terminated.

A first ancillary object of the present invention is facilitating location of a USB port connectible device after connection to a computer through a USB port when power to the USB port connectible device is terminated by computer power termination.

A second ancillary object of the present invention is facilitating location of a USB port connectible device after connection to a computer through a USB port to a computer after power to the USB port connectible device has been terminated with a computer application.

A second auxiliary object of the present invention is facilitating positive location of a USB port connectible device after connection to a computer and termination of power to the USB port connectible device by removal of the USB port connectible device from that computer.

Other objects of the present invention including efficient electronic design may be appreciated particularly in the detailed discussion of the preferred embodiment following the brief description of the drawings and nomenclature following the discussion of the principles relating to the present invention directly below.

Principles Relating to the Present Invention

In fulfillment of the objectives above it is suggested that location of a USB port connectible device that has been connected to a particular computer among a plurality of computers networked together and all usable from a single workstation be facilitated with an alarm disposed upon the device and generating an alarm signal actuated by a power off detection circuit detecting the condition of power termination to that USB port connectible device.

It is suggested that the alarm be powered by an electric charge holding element charged by a computer through a USB port during connection of the USB port connectible device to the computer: id est a capacitor; having an internal voltage when charged and supplied to the alarm in alarm signal generation. If desired provision of an optional battery, rechargeable or conventional, can be accommodated by the alarm circuitry for the purpose of prolonging the alarm signal after capacitor charge depletion.

It is further suggested that alarm control circuitry including the capacitor, alarm, and power off detection circuit be compatible with the digital circuitry of a USB port connectible device enabling alarm control by other digital logic circuitry in addition to the power off detection circuit. A power off detection circuit that compares capacitor internal voltage with external voltage supplied during connection outputting an alarm signal digital logic ‘1’ when internal voltage exceeds external voltage is suggested.

It is further suggested that the alarm control circuitry accommodate the addition of an RF transceiver powered by the computer during connection of the USB port connectible device to a computer transmitting an RF signal ‘reflected’ back to the RF transceiver by RFID in a remote unit with the absence of reception of the ‘reflected’ RF signal for a predetermined amount of time causing alarm activation.

### BRIEF DESCRIPTION OF THE DRAWINGS

FIG. 1 is an isometric view illustrating the purpose of the present invention wherein one of a plurality of computers has a USB connectible device 33 connected thereto emitting an audible alarm 21 facilitating location of that USB connectible device 33.

FIG. 2 is an electrical diagram depicting alarm control circuitry 10 in preferred embodiment of the principles relating to the present invention for the purpose illustrated in FIG. 1.

FIG. 3 is an electrical diagram of an exemplary power off detection circuit 12 possessed by the alarm control circuitry 10 of FIG. 2.

### NOMENCLATURE

7 counter
10 alarm control circuitry
11 alarm generator
12 power off detection circuit
13 alarm signal
14 base unit
15 RF transceiver
16 computer
17 capacitor
18 identification (RFID)
19 alarm control signal
20 external voltage
21 audible alarm
22 internal voltage
23 large resistor
24 small resistor
25 RF signal
26 ‘reflected’ signal
27 external voltage reverse logic
28 ID reader
29 AND gate
30 inverter (NOT gate)
31 control circuit
32 timer
33 USB port connectible device

### DETAILED DESCRIPTION OF THE PREFERRED EMBODIMENT

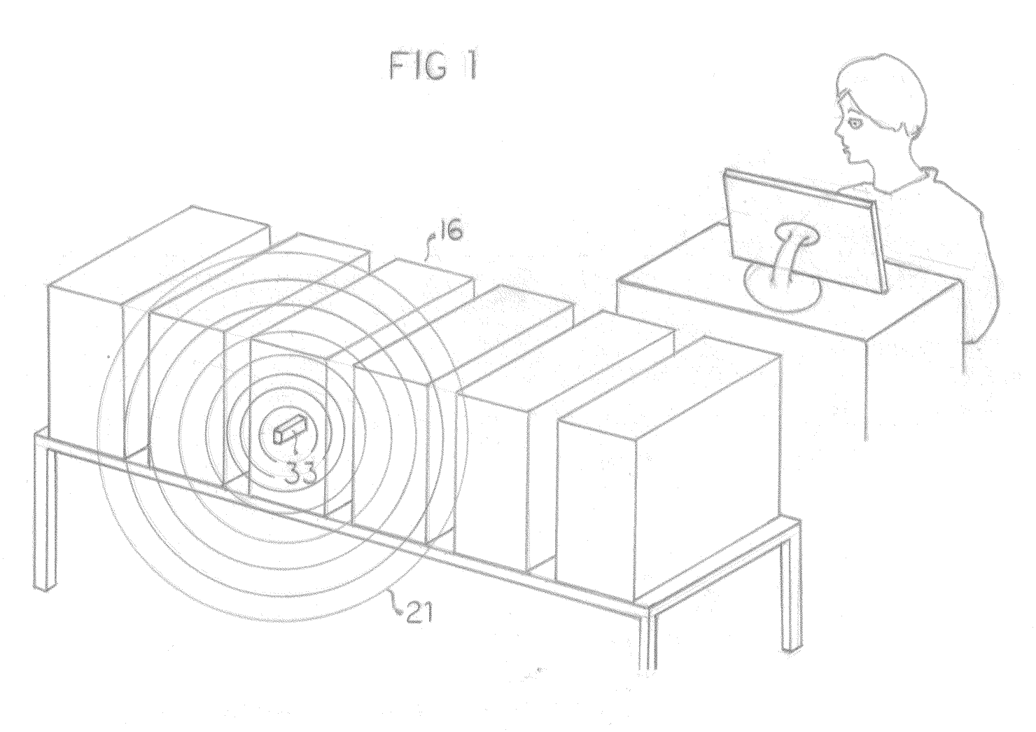

FIG. 1 depicts the owner of a USB port connectible device 33 seated in front of a monitor representing a workstation including computer control means such as a keyboard and mouse: not shown; facing an array of six computers 16 each operable from the workstation including one computer 16 having the USB port connectible device 33 connected thereto with an audible alarm 21 emanating therefrom to facilitate location of the USB port connectible device 33.

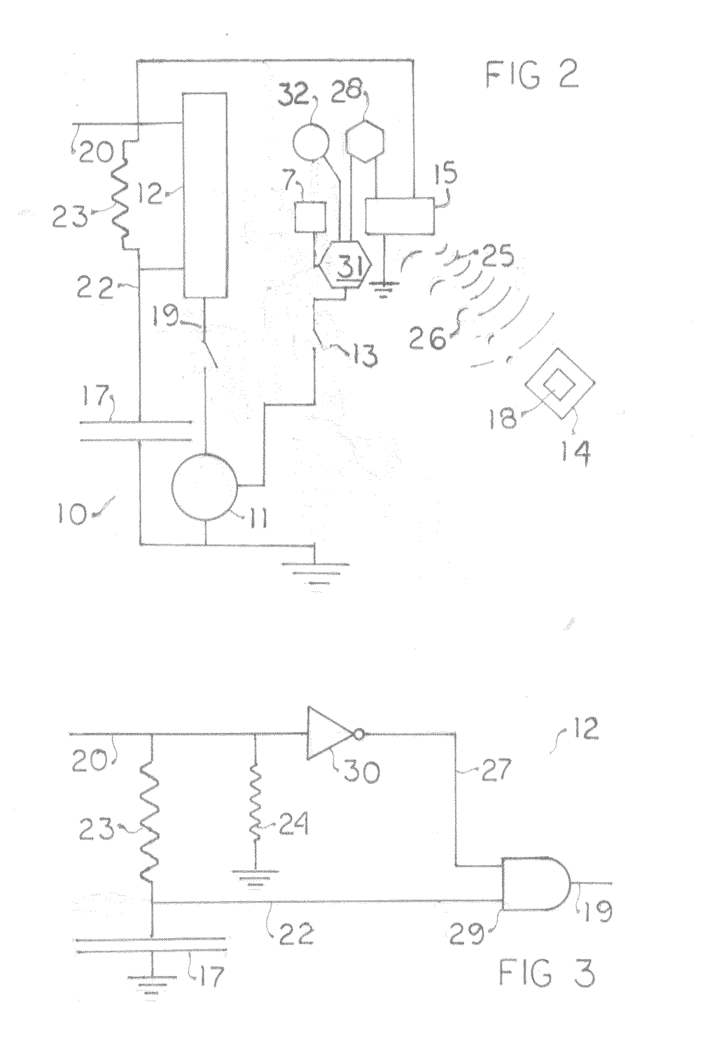

FIG. 2 depicts alarm control circuitry 10 inclusive of an alarm generator 11 that generates an audible alarm 21 when actuated, a power off detection circuit 12 outputting an alarm control signal 19 parallel a large resistor 23 between supplied external voltage 20 and the internal voltage 22 of a capacitor 17 charged by the external voltage 20. Optional elements depicted in FIG. 2 include a base unit 14 with identification (RFID) 18, a counter 7, an ID reader 28, a control circuit 31 capable of outputting an alarm signal 13, a timer 32, and a RF transceiver 15 transmitting a RF signal 25 and receiving the ‘reflected’ signal 26 from the RFID 18.

FIG. 3 depicts an exemplary power off detection circuit 12 in accordance with the preferred alarm control circuitry 10 depicted in FIG. 2 including a small resistor 24 parallel the large resistor 23, external voltage reverse logic 27 from an inverter (NOT gate) 30 which is fed along with the internal voltage 22 of the capacitor 17 into an AND gate 29 which outputs an alarm control signal 19. This power off detection circuit 12 is exemplary of any functionally equivalent circuit detecting termination of power to a USB port connectible device 33 from a computer 16 through a USB port and causing alarm 11 actuation.

This exemplary power off detection circuit 12 shown in FIG. 3 outputs an alarm control signal 19 represented as a switch in controlling the supply of power in the form of the internal voltage 22 of the capacitor 17 to the alarm generator 11 only when power to the USB port connectible device 33 is terminated. In the specific case shown in FIG. 3 control logic outputted by the detection circuit 12 comprises digital logic ‘1’ as an AND gate 29 is fed by the internal voltage 22 and the external voltage reverse logic 27.

It is emphasized that other equivalent power off detection circuits 12 outputting an alarm control signal 19 in control of the alarm generator 11 are readily devised by one practiced in the art. An example of a power off detection circuit 12 equivalent to the exemplary power off detection circuit 12 shown in FIG. 3 utilizing digital logic to output a digital logic alarm control signal 19 rather than using an AND gate 29 fed by the internal voltage 22 and the external voltage reverse logic 27 might use a NOR gate fed by the external voltage 20 and the reverse logic of the internal voltage 22 whereby output of an alarm control signal 19 digital logic ‘1’ would actuate the alarm generator 11 with supply of power in the form of internal voltage 22 from the capacitor 17.

Three cases of power termination have been recognized: (a) shutting down the computer 16, (b) using or exiting an application on the computer 16 and (c) removing the USB port connectible device 33 from the computer 16; as useful occasions for facilitating location of a particular USB port connectible device 33 left connected upon a computer 16. It is noted that in operation a USB port connectible device 33 with alarm control circuitry 10 in accordance with the principles relating to the present invention including a power off detection circuit 12 and a capacitor 17 must first be connected to a computer 16 for the purpose of charging the capacitor 17 with external voltage 20 from the computer 16.

The alarm control circuitry 10 depicted in FIG. 2 also depicts an alarm signal 13: as a switch controlled or; outputted by the control circuit 31 shown linked to a counter 7, a timer 32, and an ID reader 28 which is shown as linked to an RF transceiver 15 which is supplied with external voltage 20 derived from the computer 16 when the USB port connectible device 33 is connected to the same through a USB port. The control circuit 31 outputs this alarm signal 13 causing power to be supplied to the alarm generator 11 in the form of external voltage 20 when the counter 7 reaches a predetermined value in a predetermined amount of time as discussed below.

Both this alarm signal 13 and the alarm control signal 19 preferably comprise a digital signal in control of alarm generator 11 actuation compatible with, and hence readily implementable in, the digital circuitry of a conventional USB port connectible device 33 as all the alarm control circuitry 10 further comprises, in preferred embodiment of the principles relating to the present invention, digital circuitry as the best way of making and using an embodiment in accordance with said principles.

The optional base unit 14 has, as clearly depicted in FIG. 2, identification (RFID) 18 associated with: id est readable by; the ID reader 28. The RFID 18 in simplified terms ‘reflects’ an RF signal 25 from and back to the RF transceiver 15 which receives this ‘reflected signal’ 26 and relays the identification (RFID) 18 to the ID reader 28 linked to the control circuit 31 also linked to the timer 32 and the counter 7. This type of ‘passive’ RFID 18 actually has an RF transmitter, not shown, that is powered with a capacitor: also not shown; that is charged by the RF signal 25 received and the ‘reflected’ signal 26 is hence transmitted at intervals as opposed to the substantially continuous RF signal 25 transmitted by the RF transceiver 15. The control circuit 31 provides for digital operation readily implementable upon a conventional USB port connectible device 33.

Each ‘reflected’ signal 26 received that is ‘correct’ in having the identification (RFID) 18 readable by the ID reader 28 resets the counter 7 to zero. The counter 7 begins at zero and is incremented in value upward with each ‘reflected’ signal 26 that is missed: id est not received; by the RF transceiver 15 in the predetermined time according to the timer 32 and the known interval of the ‘reflected’ RF signal 26. When the counter 7 reaches a predetermined value the alarm generator 11 is actuated by the alarm control signal 13 outputted by the control circuit 31 and shown as a switch in FIG. 2 in indication of the supply of power to the alarm generator 11. This operation of ID reader 28, timer 32, and counter 7 as coordinated by the control circuit 31 is exemplary of digital circuit operation in actuation of the alarm generator 11 in response to the condition of a ‘missed’ reflected' signal 26 from the identification (RFID) 18 possessed by a base unit 14 remote from the USB port connectible device 33 connected to a computer 16.

The exemplary digital power off detection circuit 12 shown in FIG. 3 relies upon an inverter (NOT) gate 30 to provide external voltage reverse logic 27 to the AND gate 29 in the condition of power termination to the USB port connectible device 33. A NOR gate fed with the reverse logic of the internal voltage 22 and the external voltage 20 also would produce an alarm control signal 19 comprising digital logic: ‘1’ actuating the alarm generator 11. In any case the external voltage 20 is less than the internal voltage 22 only when power to the USB port connectible device 33 is terminated. A preferred, digital or non-digital, power off detection circuit 12 ‘compares’ the external voltage 20 with the internal voltage 22 from the capacitor 17 in detection of the condition of power from the computer 16 to the USB port connectible device 33 being terminated after being supplied to the alarm control circuitry 10.

I claim:

1. A Universal Serial Bus (USB) port connectible device locater comprising:
alarm control circuitry including an alarm generator emitting an audible alarm when activated, a power off detection circuit, and a capacitor;
said capacitor being charged by external voltage obtained from a computer when a USB port connectible device with said alarm control circuitry is powered by the computer;
said alarm generator being activated by supply of internal voltage from said capacitor when said power off detection circuit detects termination of said external voltage;
wherein said audible alarm is emitted when external voltage to said USB port connectible device is terminated after being supplied by a computer.

2. The USB port connectible device locater of claim 1 further including a base unit possessing identification (RFID) readable by an ID reader in said alarm control circuitry further including a control circuit, a counter, a timer, and a RF transceiver transmitting an RF signal when powered by said external voltage and receiving a ‘reflected’ signal transmitted at intervals by said RFID and readable by said ID reader, said counter being incremented upward in value by missing a reading of said RFID and causing activation of said alarm generator when reaching a predetermined value in a predetermined amount of time.

3. The USB port connectible device locater of claim 1 wherein said power off detection circuit compares said external power with said internal voltage in detection of the condition of power termination from said computer to said USB port connectible device.
